(19) United States
(12) Patent Application Publication
(10) Pub. No.: US 2026/0141377 A1
(43) Pub. Date: May 21, 2026

(54) HYBRID CONTROL OF DIGITAL ASSET PRIVATE KEYS

(71) Applicant: TrofiVentures LLC, Austin, TX (US)

(72) Inventors: Blake Love, Austin, TX (US); Tiago Soromenho, Austin, TX (US); Michael (Mike) Love, Austin, TX (US)

(73) Assignee: TrofiVentures LLC, Austin, TX (US)

(21) Appl. No.: 19/322,835

(22) Filed: Sep. 9, 2025

Related U.S. Application Data
(63) Continuation-in-part of application No. 19/196,953, filed on May 2, 2025, now Pat. No. 12,430,640.
(63) Continuation-in-part of application No. 18/953,851, filed on Nov. 20, 2024, now Pat. No. 12,443,947.
(60) Provisional application No. 63/721,409, filed on Nov. 15, 2024.

(51) Int. Cl. G06Q 20/36

(52) U.S. Cl. CPC G06Q 20/3674

(57) ABSTRACT

A method includes: providing a hosted digital wallet that mirrors at least a portion of data of a user digital wallet, the hosted digital wallet comprising first data indicative of a first portion of a private key; associating the hosted digital wallet with a smart contract storing second data indicative of at least a remainder of the private key that is not the first portion of the private key stored in the hosted digital wallet; determining that the user digital wallet is not compliant with one or more predetermined conditions specified via the smart contract; acquiring authentication data from one or more entities; requiring that the authentication data satisfy a security measure; and in response to the authentication data satisfying the security measure, performing one or more actions authorized by the smart contract associated with recovering the private key using the first data and second data.

### CROSS REFERENCE TO RELATED APPLICATIONS

This application is a continuation-in-part of U.S. patent application Ser. No. 19/196,953, filed May 2, 2025, which is a continuation of U.S. patent application Ser. No. 18/953,851, filed Nov. 20, 2024, all of which claim priority to U.S. provisional patent application Ser. No. 63/721,409, filed Nov. 15, 2024, each application having the same title, the contents of all earlier applications being incorporated by reference herein in their entirety.

### BACKGROUND

### 1. Field

The disclosed subject matter generally pertains to managing keys used for securing digital assets.

### 2. Description of the Related Art

Digital wallets such as those used for cryptocurrency store the private key(s) which are the only access to digital assets. Generally, a user must retain a password or phrase to access the wallet to obtain the key(s) stored in the wallet. In such cases, the digital wallet may be referred to as a self-custody wallet because the user is responsible for the wallet, including managing and retaining availability of the password or phrase. If the password or phrase is lost, for example if the user loses it, the password or phrase is not available and therefore nor are the key(s) which prove ownership of the digital assets.

### SUMMARY

In summary, an embodiment provides a method, comprising: providing, using a set of one or more processors, a hosted digital wallet that mirrors at least a portion of data of a user digital wallet, the hosted digital wallet comprising first data indicative of a first portion of a private key; associating, using the set of one or more processors, the hosted digital wallet with a smart contract storing second data indicative of at least a remainder of the private key that is not the first portion of the private key stored in the hosted digital wallet; determining, using the set of one or more processors, that the user digital wallet is not compliant with one or more predetermined conditions specified via the smart contract; acquiring, using the set of one or more processors, authentication data from one or more entities; requiring, using the set of one or more processors, that the authentication data satisfy a security measure; and in response to the authentication data satisfying the security measure, performing one or more actions authorized by the smart contract associated with recovering the private key using the first data and second data.

In an embodiment, the security measure is one or more of a biometric authentication protocol, a multi-factor authentication protocol, and a multi-signature protocol. In an embodiment, the multi-factor authentication protocol comprises a multi-entity authentication process. In an embodiment, the authentication data is indicative of multi-entity consent that satisfies the multi-signature protocol. In an embodiment, the multi-signature protocol comprises a threshold requirement for having a predetermined number of signatures.

In an embodiment, the requiring that the authentication data satisfy the security measure includes confirming biometric data matches one or more predetermined entities. In an embodiment, the one or more entities are defined by one or more predefined user roles. In an embodiment, a method comprises determining one or more predefined conditions have occurred; wherein the one or more predefined conditions occurring enables the one or more predefined user roles. In an embodiment, the one or more predefined conditions comprise satisfying a condition of a beneficiary arrangement specified via the smart contract. In an embodiment, the one or more predefined user roles are thereafter authorized to recover the private key.

An embodiment provides a system comprising components such as a hosted digital wallet and programs or parts thereof that implement smart contract functionality, some of which may be stored and executed on a distributed ledger. In an embodiment, the system comprises a set of one or more processors and executable code stored in a non-transitory storage medium, the executable code being used by the set of one or more processors to perform one or more of the methods, or part thereof, as described herein.

An embodiment provides a computer program product comprising a non-transitory computer readable medium comprising code configurable to be executable by a set of one or more processors to perform one or more of the methods, or part thereof, as described herein.

The foregoing is a summary and thus may contain simplifications, generalizations, and omissions of detail; consequently, those skilled in the art will appreciate that the summary is illustrative only and is not intended to be in any way limiting.

These and other features and characteristics of the example embodiments, as well as the methods of operation and functions of the related elements of structure and the combination thereof, will become more apparent upon consideration of the following description and the appended claims with reference to the accompanying drawings, all of which form a part of this specification. It is to be expressly understood, however, that the drawings are for the purpose of illustration and description only and are not intended as a definition of the limits of a claimed invention.

### BRIEF DESCRIPTION OF THE DRAWINGS

FIG. 1 illustrates an example system according to an embodiment.

FIG. 2 illustrates an example method according to an embodiment.

FIG. 2A illustrates example outcomes according to an embodiment.

FIG. 3 illustrates an example method according to an embodiment.

FIG. 4 illustrates example components according to an embodiment.

FIG. 5 illustrates an example method according to an embodiment.

FIG. 5A through FIG. 5F illustrate example methods according to an embodiment.

FIG. 6 illustrates a diagram of example system components according to an embodiment.

### DETAILED DESCRIPTION OF EXAMPLE EMBODIMENTS

The described features, structures, or characteristics of the example embodiments may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well known structures, materials, or operations are not shown or described in detail to avoid obfuscation.

To address the problem of lost access, conventional solutions include recovery service providers who simply offer password recovery solutions similar to those used to access conventional digital accounts. A problem with this approach is that the recovery service may have access to user private information associated with the digital wallet, for example access to the entire password key, directly or indirectly. Thus, while offering a convenience of recoverability, there is an added security risk in that trust is placed in the password recovery service that can be circumvented, for example through hacking. A similar concern may arise in escrow servicing arrangements, where a single entity has access to a private key that provides ownership to digital assets.

An embodiment therefore provides a solution to digital wallet password recovery and access in the form of hybrid custody for the data required to access the wallet or prove ownership of the associated assets, for example a password, referred to herein as a “private key.” The private key is split into parts which are placed into trusted storage under the control of different parties. In an embodiment, a service provider offering a hosted wallet only has access to part, but not all, of a user's wallet private key, with the other part stored in a smart contract on a blockchain. This adds additional security over conventional passwords in two ways: 1) if someone finds or hacks the password to the smart contract, they only have access to part of the wallet private key; and 2) if the password is lost or can no longer be accessed, the smart contract can be constructed to release the part under certain condition(s) specified by the smart contract. Further, an embodiment permits a hosted service to secure a part of the private key in one or more smart contracts that release the part of the private key conditionally, enhancing the trust placed in a service used to hold assets for conditional outcomes, such as for escrow services or wagering services.

By way of example, a first part of a key may be retained by a hosted wallet provided by a service provider. A second part of the key may be placed into a smart contract, recorded on a distributed ledger. The smart contract will conditionally release the second part of the key, allowing it to be combined with the first part, for recovery of the full key. The smart contract releases the second part of the key under specific conditions, for example expiration time of the contract, a period of non-refresh of the contract, a provided termination secret known only to the user, a release secret known only to a third party, etc. Thus, via numerous techniques, if a digital wallet is inaccessible or a private key is otherwise to be conditionally recovered, the private key may be recovered by satisfying the condition(s) specified in the smart contract. Note that the smart contract may or may not have a component requiring the service provider to confirm its identity in some manner.

The description now turns to the figures. The illustrated example embodiments will be best understood by reference to the figures. The following description is intended only by way of example, and simply illustrates certain example embodiments.

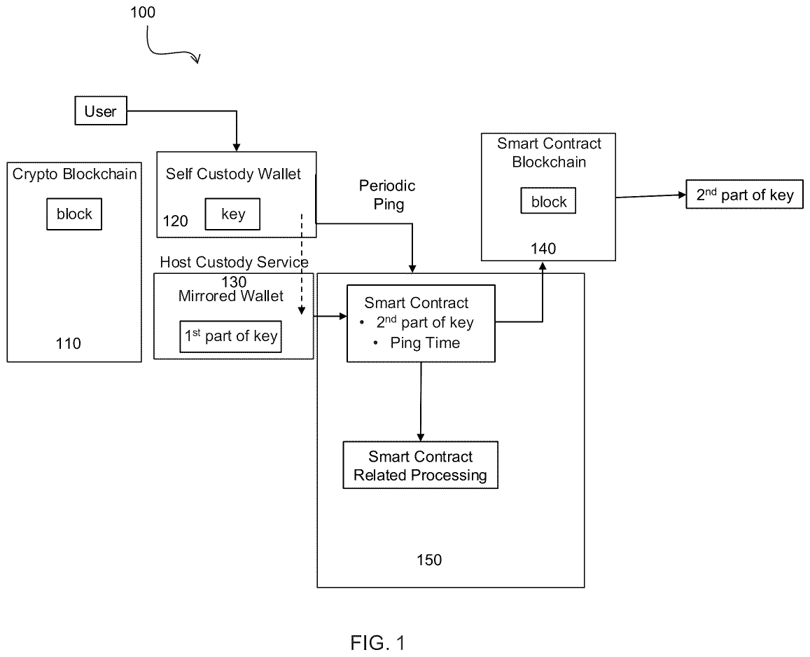

Illustrated in FIG. 1 is an example system 100 and components that may be included in an embodiment or interacted with according to an embodiment. System 100 includes a self-custody wallet 120, for example a digital wallet, stored on a user device such as a mobile computing device, containing the access keys used to prove identity to assets stored on a blockchain 110. Self-custody wallet 120 may be accessed via a private key, facilitating control of the assets. Self-custody wallet 120 may have additional features, such as providing intermittent messages that indicate the user(s) are “alive” or that self-custody wallet 120 is on a computer that is operational. In an embodiment, self-custody wallet 120 sends an SMS message to a list of user(s) and if one user responds then an alive message is sent by self-custody wallet 120. In another embodiment, a third-party service tracks use of services, for example banking or credit cards, that indicate the user is alive, allowing the third-party service to act as a proxy for responding to a request from self-custody wallet 120 and so not bothering the user. In yet another embodiment, use of a host custody service such as described below may be able to act as a proxy and respond to a request from self-custody wallet 120.

In an embodiment, a host custody service may provide a mirrored wallet 130, also referred to herein as a hosted digital wallet or hosted-custody digital wallet, signifying that the host custody service controls content of the mirrored wallet 130. As illustrated, mirrored wallet 130 may include a first part of the private key of self-custody wallet 120. In some embodiments, the encrypted self-custody wallet 120 can also be stored as part of the mirrored wallet 130 as part of a backup service. This can be done with no risk, since the backup wallet can only be accessed with the full private key, of which only part is stored in the mirrored wallet 130.

Host custody service may include a processing component 150 that facilitates formation and transmission of a smart contract added to a smart contract blockchain 140. The smart contract is recorded as a block in smart contract blockchain 140. Processing component 150 provides an interface to the smart contract and related functions, as further described herein. In an embodiment illustrated in FIG. 1, the smart contract may be configured with one or more conditions, such as ping timing as well as the second part of the private key. As such, the smart contract may be configured to determine, for example periodically or intermittently, whether the owner(s) of the self-custody wallet 120 is alive. For example, ping messages or responses to ping messages should be received from self-custody wallet 120 per requirements of the smart contract. In the event a ping message or response is not obtained the smart contract is configured to release the second part of the private key, allowing it to be joined with the first part of the private key to recover or access the digital assets in self-custody wallet 120. In an embodiment, the lack of a ping message or response triggers a programmable sequence of steps before the second part of the private key is released, such as repeating the ping test or waiting for a pre-determined length of time. As will be appreciated, there are a variety of ways to establish communications or pings to determine if self-custody wallet 120 is compliant with the smart contract, for example implementing reporting or responding functionality in self-custody wallet 120.

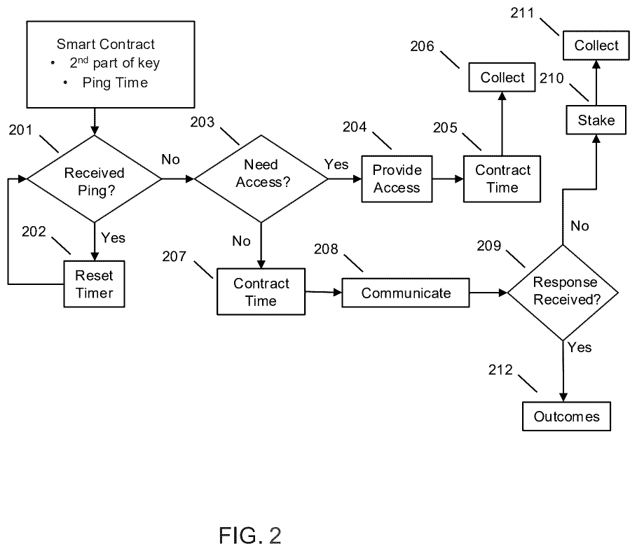

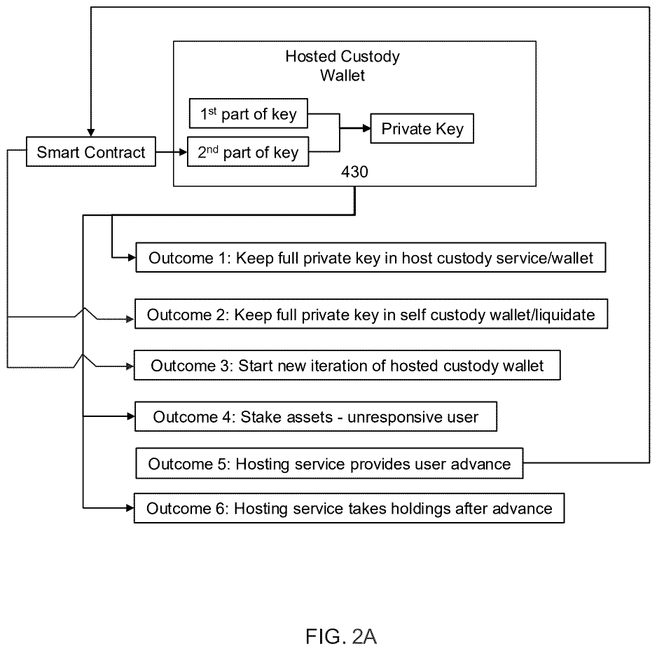

Referring to FIG. 2, an example of processing related to a smart contract, for example implemented using processing component 150, is illustrated. In FIG. 2, a smart contract stores logic, e.g., setting forth conditions such as ping time or expiry rules, and stores the part of the private key of a self-custody wallet 120. In an embodiment, the smart contract or an off-chain application associated therewith is used to determine if a ping message is received at 201. It is noted that “ping message” is used as a term to indicate an agreed upon data communication utilized to determine a compliance with the smart contract, for example accessibility of a self-custody wallet 120 or “alive” status of a user of self-custody wallet 120. The ping message may take a variety of formats such as JSON, XML, etc. The rules of timing or frequency for ping messages may be agreed and configured using processing component 150, such as regular reporting according to a schedule, response to another condition, etc. If a ping message is received, the smart contract proceeds, the ping timing is reset at 202, and no action is required, i.e., all is well and self-custody wallet 120 remains accessible to its owning user. Further the smart contract may have an expiry condition that if all ping messages were received and no changes over a period, the smart contract expires, requiring a new contract. In another embodiment, there may be a “lock-out” condition that locks access to the part of the private key stored in the smart contract for a per-determined time after receipt of a ping message.

In contrast, as shown in FIG. 2, the ping message not being received at 201 is indicative of a potential issue with self-custody wallet 120, i.e. the wallet is inaccessible and the private key is deemed lost. As shown, if an authorized user requires access, as determined at 203, a variety of processing options may be conditionally utilized and lead to various outcomes, some of which are described to illustrate the varying possibilities.

As shown in FIG. 2 at 203, it may be determined that an authorized user needs access following a specific communication to the user, for example sending an email to the user at an agreed upon time after missing a ping. If the authorized user needs immediate access but is locked-out because they have to wait for the smart contract to expire, the host service provider may provide, as indicated at 204, alternative or different assets, such as fiat money in place of a digital asset of self-custody wallet 120, using the digital asset (which is guaranteed to be released at a future time) as security. By way of example, a smart contract or related logic may set forth that a discounted value of fiat currency may be obtained in exchange for forfeit of one or more of the digital assets of self-custody wallet 120. In one example, a discounted rate or percentage of fiat money (fiat currency) is provided at 204. Following the providing at 204, the expiration time of the smart contract is reached as indicated at 205 and the host custody service may collect 206 the original digital assets of self-custody wallet 120 by virtue of release of the second part of the key, allowing the full key of self-custody wallet 120 to be recovered. In an embodiment, the smart contract may be configured to expire early in the case where the advanced, alternative asset is provided to the user on proof of the fiat money transfer.

Alternatively, if the user does not need early access as determined at 203, the contract time of the smart contract will expire at the predetermined time, as shown at 207, and a communication may be made with an authorized user, as shown at 208. The communication at 208 may include informing the user that although no pings were received and while the continued availability of the self-custody wallet cannot be confirmed, the user is given a chance to select from options for handling the expiration of the smart contract. If no response is received, as determined at 209, the digital assets may be utilized as abandoned assets, for example staked at 210 and used to collect against, as indicated at 211. Alternatively, if a response from the user is forthcoming, one of a variety of outcomes could be used, as indicated at 212. Examples of outcomes 212 include, but are not limited to, renewing the smart contract, terminating the smart contract and removing the first part of the key from the hosted custody wallet such that the user may liquidate the assets or otherwise handle the self-custody wallet as desired with no further involvement of hosted custody service, and converting to full hosting where the full private key is stored in mirrored custody wallet 130.

To illustrate, and referring to FIG. 2A, the smart contract may be configured to release the second part of the key in defined circumstances, allowing the hosted custody wallet 430 to obtain the other part of the private key. Alternatively, or additionally, the smart contract may be configured to not permit the release of the second part of the key under any conditions, for example the user wishes to stop using hosted custody wallet 430 or the user wishes to use a different smart contract.

By way of example, at the end of the smart contract the second part of the private key may be released and may be joined with the first part of the key to form the full private key by hosted custody wallet 430. In the examples illustrated in FIG. 2A, the full key is recovered and stored in hosted custody wallet 430, which corresponds to outcomes 1, 4 and 6 in the FIG. 2A. However, other outcomes may be utilized, as illustrated, including the providing of the full key to self-custody wallet, outcome 2, in which case the host custody service provider does not acquire the second part of the key, as the smart contract is configured to not provide the full key to hosted custody wallet 430. Also illustrated is that the smart contract may be renewed in outcome 3, which again may be facilitated by smart contract logic and again does not make the second part of key available to hosted custody wallet 430.

In another example outcome, the digital assets in mirrored wallet 130 in outcome 4 may be considered abandoned and used by the host custody provider, such as for staking prior to contract expiry. In such a case, the second part of the key is provided to hosted custody wallet 430 for full key recovery after expiration of the smart contract.

As an additional example, the host custody provider may provide an advance for access to the digital assets, such fiat money payment at a discount (outcome 5), followed by the host custody service obtaining the second part of the key at smart contract expiration and collecting the original digital assets using the second part of the key (outcome 6).

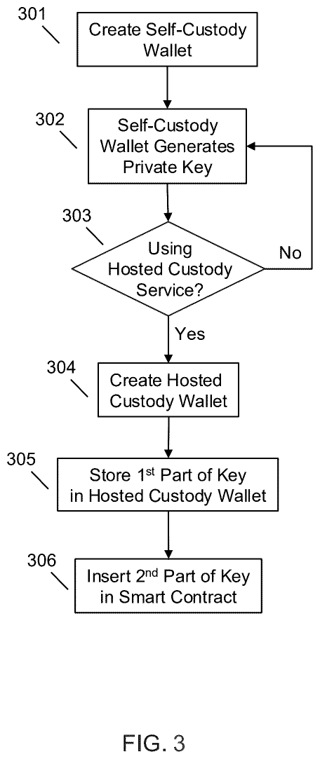

FIG. 3 illustrates an example set up procedure for using a host custody service. In the example of FIG. 3, a user creates a self-custody wallet at 301, for example by installing a mobile application. A self-custody wallet generates a private key, as illustrated at 302, which encrypts and secures the key to digital assets added to the self-custody wallet such as cryptocurrency in a blockchain. Note that in an embodiment, the wallet may have only one asset, in which case the private key may be the same as the secured key. Generating the private key may use any accepted encryption scheme used by a digital wallet. If using a hosted custody service, as determined at 303, a hosted custody wallet is created, as illustrated at 304. The hosted custody wallet stores part of the private key, as illustrated at 305. The other or remaining part of the private key is stored securely in a related smart contract, as illustrated at 306, and is only conditionally available to the hosted custody wallet and provider thereof, for example expiry of the smart contract where the authorized user is unresponsive or has received an advance via a fiat payment.

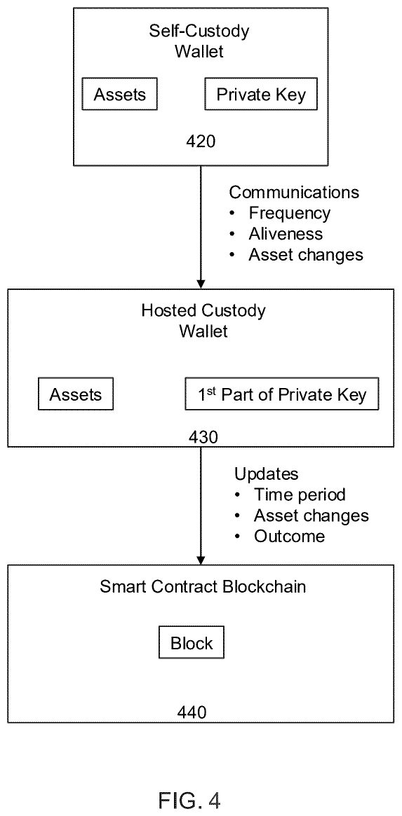

As shown in FIG. 4, self-custody wallet 420 stores encrypted keys to digital assets and its private key. Hosted custody wallet 430 mirrors self-custody wallet 420 by storing a copy of at least a portion of self-custody wallet 420, for example a copy of the first part of the private key as well as the encrypted asset data. Self-custody wallet 420 is associated with hosted custody wallet 430 by an application or control logic. The application regulates the behavior of self-custody wallet 420 and hosted custody wallet 430, for example setting forth communication conditions such as frequency of ping messages, an aliveness indicator, management of state changes such as changes to assets in self-custody wallet 420, or a combination of the foregoing. This permits host custody wallet 430 to interact with smart contract blockchain 440, storing the associated smart contract, for example to provide updates to timing (e.g., of expiry of smart contact), asset changes (e.g., amount or ownership of the original digital assets of self-custody wallet 420), and a chosen outcome, coded into the smart contract, for example as illustrated in FIG. 2A.

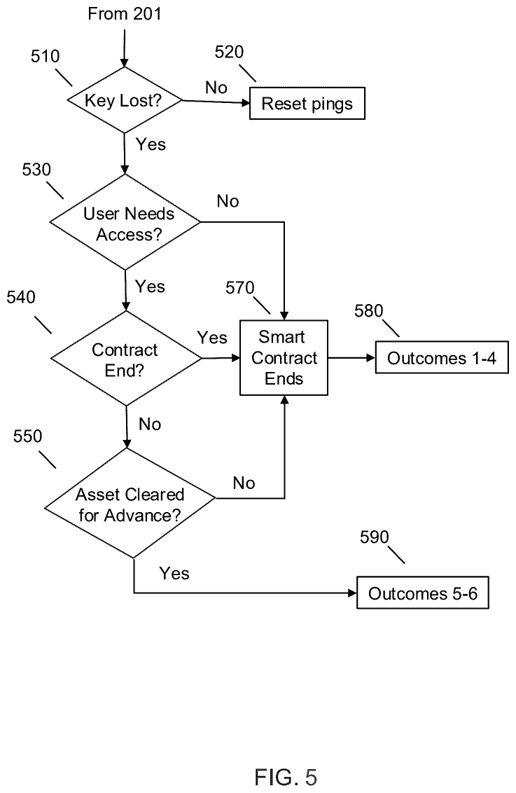

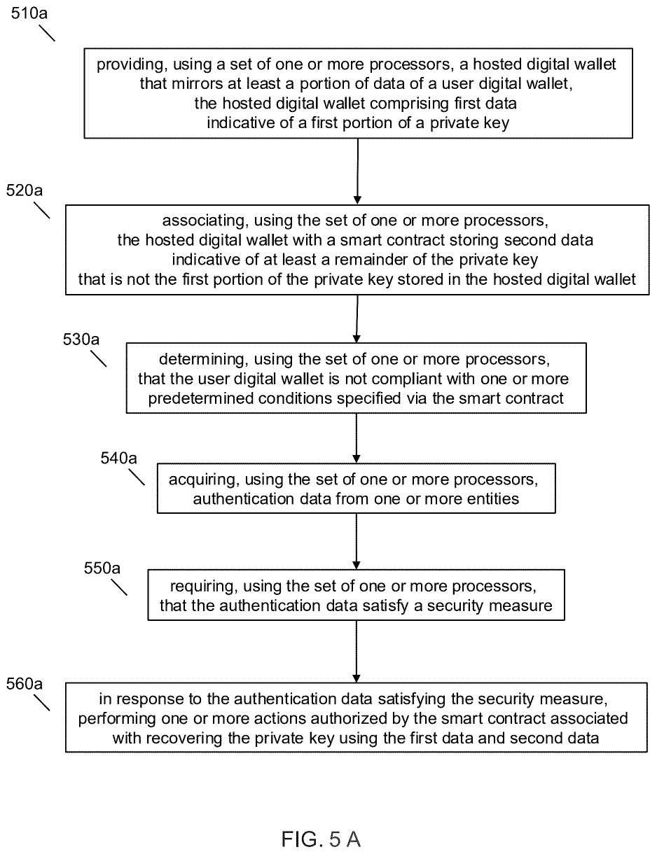

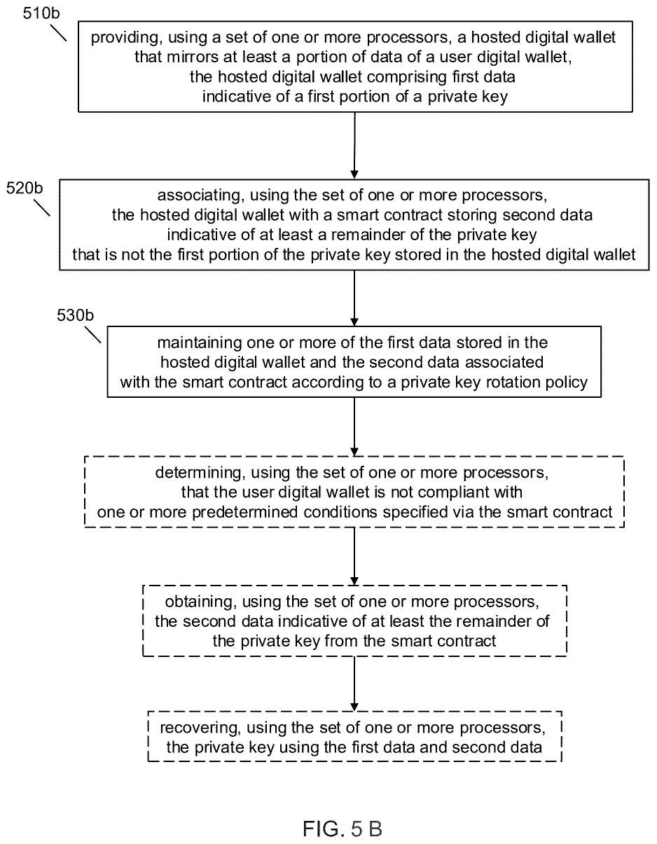

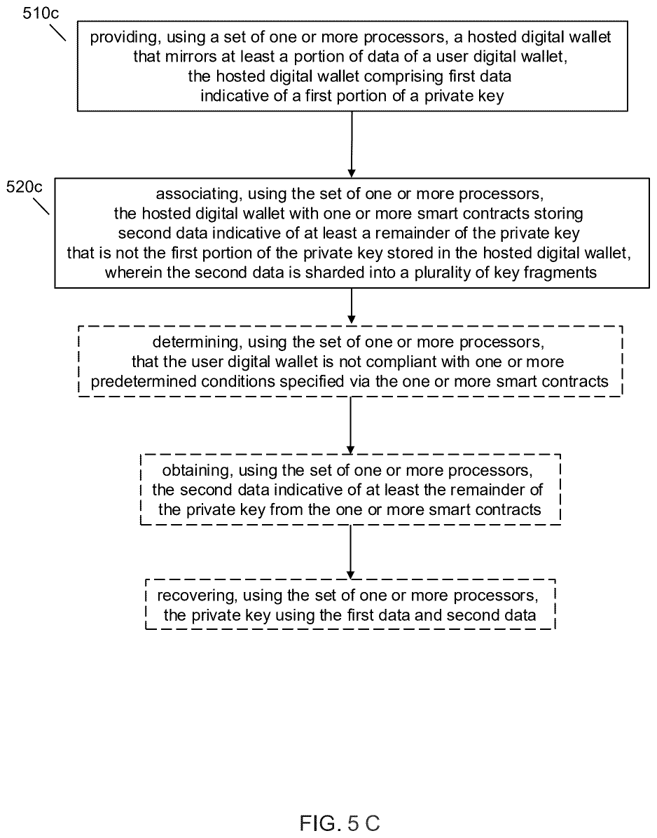

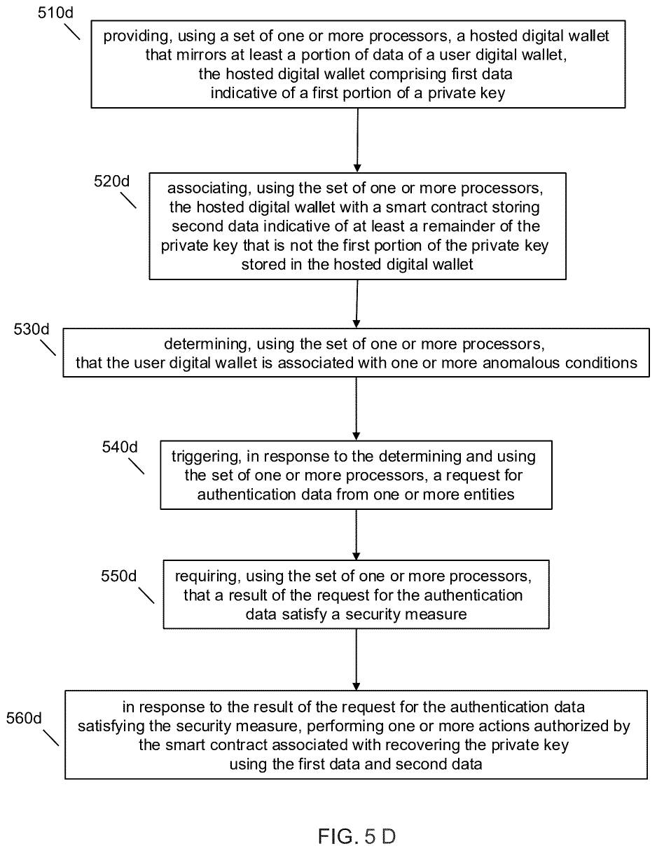

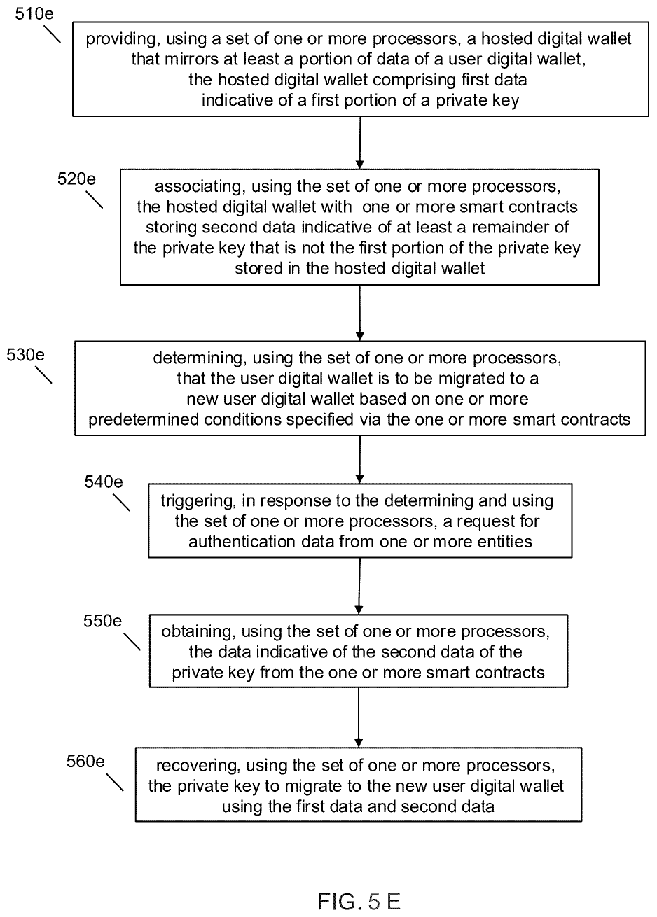

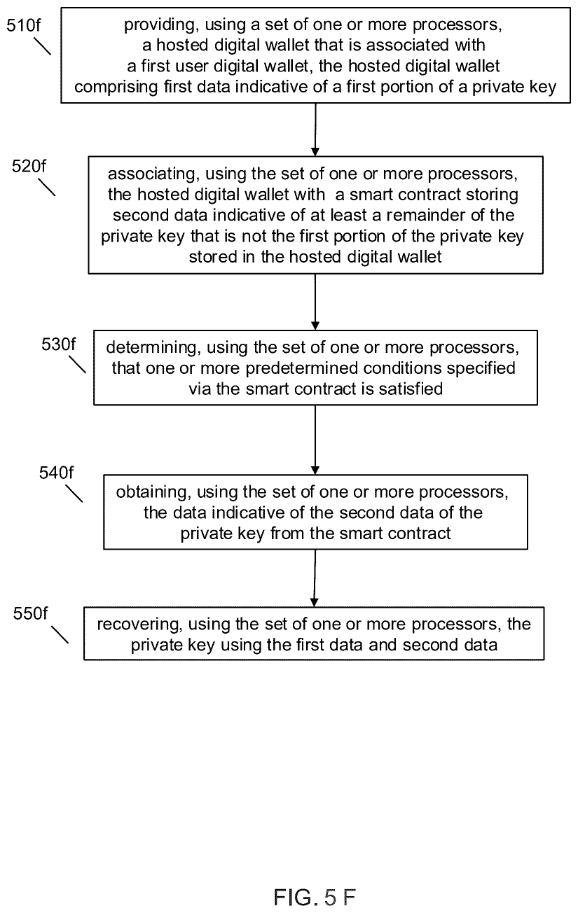

Because one motivation to use a hybrid custody arrangement according to an embodiment is to secure access to digital assets in the event that an authorized user loses access to a self-custody wallet, FIG. 5 illustrates an example process that may be provided according to an embodiment for determining and handling key loss. As illustrated, following a determination of data that is indicative of lost access to or inaccessibility of self-custody wallet 120, for example as determined at step 201 of FIG. 2, an embodiment may determine if that self-custody wallet is inaccessible, for example confirm with the user via communication that the key is lost. If the key is not lost but a ping message was missed due to a network anomaly or some other consideration, then further action may be required to set the status quo, such as a reset of the ping timer in the smart contract as indicated at 520.

In the case that the key is lost, it may be determined whether the user needs access, as indicated at 530, and in turn whether the smart contract has ended or expired, as indicated at 540. As indicated in FIG. 5, if the user does not need access, the smart contract may be left to expire as defined, indicated at 570, following which any of the outcomes 1-4 may be implemented, as illustrated at 580. That is, the smart contract will expire and conditionally release the second part of the key, permitting key recovery, e.g., by host custody wallet 430, as illustrated in FIG. 4. Similarly, in a condition where it is determined that the key is lost at 520 and the user needs access at 530, if the contract has expired, the second part of the key is available for recovery as indicated at 580.

In a condition where the user has lost the key, as determined at 510, the user needs access, as determined at 530, and the contract has yet to expire, as determined at 540, then a check of whether the user account or assets thereof are cleared for an advance, as indicated at 550. In this case, if the asset(s) have been cleared for an advance, outcomes 5-6 may be utilized, i.e., custody service provider or partner thereof may provide an advance. In some cases, the advance may take the form of an alternative asset, such as fiat money that is provided at a discounted amount. In contrast, if the asset is not cleared for an advance, then the contract may await expiration, as indicated at 570, where one of outcomes 1-4 may be pursued.

In an embodiment, a hybrid custody arrangement may be used in combination with an authentication method, for example as illustrated in FIG. 5A. In an embodiment, a method includes providing, using a set of one or more processors, a hosted digital wallet that mirrors at least a portion of data of a user digital wallet, the hosted digital wallet comprising first data indicative of a first portion of a private key, as indicated at 510a. As described herein, the method may include associating, using the set of one or more processors, the hosted digital wallet with a smart contract storing second data indicative of at least a remainder of the private key that is not the first portion of the private key stored in the hosted digital wallet, as indicated at 520a. In an embodiment, the method includes determining, using the set of one or more processors, that the user digital wallet is not compliant with one or more predetermined conditions specified via the smart contract, as indicated at 530a.

As shown in FIG. 5A, in an embodiment the method includes acquiring, using the set of one or more processors, authentication data from one or more entities, as indicated at 540a. In an embodiment, the authentication data may take a variety of forms such as signature data, biometric data, oracle network data, etc. For example, in an embodiment the authentication data is indicative of multi-entity consent that satisfies a multi-signature protocol. By way of example, an embodiment may utilize a multi-signature mechanism where multiple parties (e.g., users, trusted third parties, designated heirs, etc.) must approve the release of the second part of the private key before recovery, allowing for faster execution of smart contract-based recovery processes. Such a multi-signature mechanism may enhance security by preventing unauthorized recovery even if one component (e.g., smart contract) is compromised. As may be appreciated, a multi-signature mechanism or protocol may be implemented using a variety of techniques, including the use of smart contract logic, for example defining a threshold amount of signatures required, the entities required to sign or provide consent, the order of consent or signature, etc. Thus, in an embodiment a multi-signature protocol comprises a threshold requirement for having a predetermined number of signatures.

In an embodiment, the method includes requiring, using the set of one or more processors, that the authentication data satisfy a security measure, as indicated at 550a. For example, in an embodiment the security measure is one or more of a biometric authentication protocol, a multi-factor authentication protocol, and a multi-signature protocol. For example, an embodiment may require that the authentication data satisfy a multi-factor authentication protocol, such as when confirming a required signature has been provided as called for by logic of the smart contract. Thus, in an embodiment, a multi-factor authentication protocol comprises or is coordinated with a multi-entity authentication process. For example, in an embodiment, the requiring that the authentication data satisfy the security measure includes confirming biometric data matches one or more predetermined entities. In an embodiment, a method such as shown in FIG. 5A incorporates biometric authentication (e.g., fingerprint, facial recognition, etc.) or multi-factor authentication as an additional security measure before releasing the second part of the private key from the smart contract. Use of biometric authentication data or a multi-factor authentication protocol strengthens authentication beyond standard key management practices and allows for expedited recover of the private key while ensuring security.

In an embodiment, a method for example as outlined in FIG. 5A may include use of role-based access controls (RBAC). For example, in an embodiment the one or more entities are defined by one or more predefined user roles, and the method may include determining one or more predefined conditions have occurred, where the one or more predefined conditions occurring enables the one or more predefined user roles. For example, the one or more predefined conditions may comprise satisfying a condition of a beneficiary arrangement specified via the smart contract. An embodiment therefore provides a system that enables different levels of access to, e.g., digital wallets or digital assets, based on predefined user roles (e.g., owner, backup custodian, emergency contact, required third-party signatory, counter-party, escrow beneficiary, trustee, etc.) with distinct permissions for asset recovery or key access. An embodiment therefore allows for secure delegation of access and ensures controlled recovery without full private key exposure. As one non-limiting example, an embodiment integrates with legal digital estate planning services, allowing users to set legally recognized beneficiaries for their digital assets and ensuring compliant succession planning via smart contracts. Thus, an embodiment may support automatic inheritance and escrow solutions that ensures compliance with regulations and legal requirements.

As illustrated at 560a of FIG. 5A, in response to the authentication data satisfying the security measure, the method may include performing one or more actions authorized by the smart contract associated with recovering the private key using the first data and second data. For example, the smart contract may allow for private key recovery after the security measure is satisfied. As described herein, third-party or external systems may be incorporated into a method provided by an embodiment, for example a decentralized oracle network. For example, an embodiment may integrate a decentralized oracle network (e.g., CHAINLINK) to verify predefined conditions, such as real-world identity verification, verification of certain facts such as probate proceedings closing, etc., before releasing the second portion of the private key. In other words, such a third-party or external system may be used as part of a process such as a security mechanism or protocol according to an embodiment, for example allowing verification of external real-world events (such as the presence or authenticity of legal documents, public notices, etc.), which prevents fraudulent recovery requests and enhances trustless security and decentralization.

In an embodiment, a method may include using key fragment rotation, as illustrated in the example of FIG. 5B. An embodiment periodically rotates and updates private key fragment(s) stored in one or more of a hosted digital wallet and a smart contract to enhance security, for example utilizing randomization techniques to prevent pattern manipulation. As illustrated, an embodiment may include a method of providing, using a set of one or more processors, a hosted digital wallet that mirrors at least a portion of data of a user digital wallet, the hosted digital wallet comprising first data indicative of a first portion of a private key, indicated at 510b. As described herein, the method may include associating, using the set of one or more processors, the hosted digital wallet with a smart contract storing second data indicative of at least a remainder of the private key that is not the first portion of the private key stored in the hosted digital wallet, indicated at 520b. Further, an embodiment may include maintaining one or more of the first data stored in the hosted digital wallet and the second data associated with the smart contract according to a private key rotation policy, indicated at 530b.

By way of example, the maintaining indicated at 530b may include using a private kay rotation policy that acts to update one or more of the first data and the second data, for example based on a determined time. In an embodiment, the method includes utilizing a key management service to supply one or more updates for the first data or the second data. The use of a private key rotation policy may reduce the risk of private key compromise, e.g., due to long resident time in a smart contract lasting years or decades, and may even provide quantum-resistant security by facilitating timely rotation of key fragments. In an embodiment, following rotation of one or more of the key fragments, the related entities such as a user digital wallet may be updated to reflect the changed key fragments. As with other elements, as illustrated in FIG. 5B, certain steps of the method, such as determining smart contract compliance or non-compliance, obtaining the second data, and recovering the private key, may be included, consolidated, changed, or omitted in various embodiments, indicated here with use of dashed lines.

As illustrated in the example of FIG. 5C, an embodiment provides a method of secure private key sharding, for example across multiple smart contracts and/or multiple blockchains, which may be of different type. In an embodiment, a private key is sharded, where key fragments are stored across multiple independent blockchains instead of a single smart contract, ensuring redundancy and decentralized security. Private key sharding may prevent single-chain failures from blocking recovery or related processing, as well as enhance fault tolerance and resilience.

In the example of FIG. 5C, a method may include providing, using a set of one or more processors, a hosted digital wallet that mirrors at least a portion of data of a user digital wallet, the hosted digital wallet comprising first data indicative of a first portion of a private key, as indicated at 510c. In an embodiment, the method may include associating, using the set of one or more processors, the hosted digital wallet with one or more smart contracts storing second data indicative of at least a remainder of the private key that is not the first portion of the private key stored in the hosted digital wallet, wherein the second data is sharded into a plurality of key fragments, as indicated at 520c.

In an embodiment, each of the plurality of key fragments comprises identical data, i.e., the same key fragment is stored multiple times in different smart contracts, which may be placed on different blockchain types. In an embodiment, each of the plurality of key fragments comprises distinct data, i.e., different pieces or portions of the private key fragment are stored in multiple smart contracts, which may be placed on different blockchain types. Thus, in an embodiment, the one or more smart contracts comprise a plurality of smart contracts where different ones of the plurality of smart contracts are stored on a plurality of different blockchain types.

An embodiment provides cross-platform wallet compatibility and interoperability, i.e., is designed to work across multiple blockchain protocols (e.g., ETHEREUM, Bitcoin, SOLANA, etc.) to support seamless private key recovery and hybrid custody across different digital wallets, as selected by the user or via the host system. This expands usability and ensures that end users are not locked into a particular blockchain platform. For example, in an embodiment, the user digital wallet is one of a plurality of selectable user digital wallet types, and the plurality of selectable user digital wallet types is associated with respective ones of a plurality of different blockchain types.

An embodiment provides user-selectable hybrid custody providers with blockchain auditing. In an embodiment, users can select a preferred hosted custody provider and self-custody wallet provider, enabling mix-and-match hybrid custody across multiple service providers, with selections recorded and auditable on a blockchain. Thus, in an embodiment, a method such as illustrated in FIG. 5C may include receiving one or more indications selecting the plurality of different blockchain types to utilize. In an embodiment, the plurality of smart contracts is configured responsive to the one or more indications, and the one or more indications are recorded on a distributed ledger in an auditable fashion.

As with other elements, as illustrated in FIG. 5C, certain steps of the method, such as determining smart contract compliance or non-compliance, obtaining the second data, and recovering the private key, may be included, consolidated, changed, or omitted in various embodiments, indicated here with use of dashed lines. In an embodiment where private key fragment sharding is utilized or multiple providers (such as multiple blockchain types) are selected, the obtaining of the data indicative of the second data of the private key from the one or more smart contracts may include accessing a plurality of smart contracts in a coordinated fashion to recover the private key or key fragments, for example as designated or defined by smart contract logic. This may include conversion steps, e.g., converting data stored in one blockchain platform to a format consumable by a service offered by another blockchain platform.

Illustrated in FIG. 5D is an example embodiment of using an artificial intelligence-based user behavior monitoring for risk detection. An embodiment integrates AI/ML-based anomaly detection that monitors user wallet activity and flags unusual behavior (e.g., sudden inactivity, abnormal access attempts, etc.) before triggering private key recovery verification processes. In an embodiment, a method includes providing, using a set of one or more processors, a hosted digital wallet that mirrors at least a portion of data of a user digital wallet, the hosted digital wallet comprising first data indicative of a first portion of a private key, indicated at 510d. The method may include associating, using the set of one or more processors, the hosted digital wallet with a smart contract storing second data indicative of at least a remainder of the private key that is not the first portion of the private key stored in the hosted digital wallet, indicated at 520d.

As shown at 530d, the method may include determining, using the set of one or more processors, that the user digital wallet is associated with one or more anomalous conditions. For example, the one or more anomalous conditions may comprise one or more of user inactivity and abnormal access attempts associated with the user digital wallet. The anomalous conditions may be defined in smart contract logic. Further, an embodiment may provide anomaly detection or may request analysis using an external or third-party anomaly detection service, e.g., via application programming interface (API) call. Thus, in an embodiment, the determining that the user digital wallet is associated with one or more anomalous conditions comprises obtaining, from an anomaly detection service, an indication of the one or more anomalies. In an embodiment, the anomaly detection service utilizes one or more models to evaluate data associated with activity of the user digital wallet. In an embodiment, the method comprises supplying the data associated with activity of the user digital wallet to the anomaly detection service.

As illustrated in FIG. 5D, in an embodiment a method includes triggering, in response to the determining of an anomalous condition, and using the set of one or more processors, a request for authentication data from one or more entities, indicated at 540d and requiring, using the set of one or more processors, that a result of the request for the authentication data satisfy a security measure, indicated at 550d. In an embodiment, the security measure is one or more of a biometric authentication protocol, a multi-factor authentication protocol, and a multi-signature protocol. By way of example, the multi-factor authentication protocol comprises a multi-entity authentication process, where the authentication data may be indicative of multi-entity consent that satisfies the multi-signature protocol.

In an embodiment, the requiring that the result of the request for the authentication data satisfy the security measure, indicated at 550d, includes confirming biometric data matches one or more predetermined entities. In an embodiment, the requiring that the result of the request for the authentication data satisfy a security measure, indicated at 550d, comprises requiring a determined amount of time to expire, after the determining that the user digital wallet is associated with one or more anomalous conditions, prior to performing the one or more actions authorized by the smart contract associated with recovering the private key using the first data and second data. In an embodiment, the determined time may be provided as a temporary lockout mechanism.

As illustrated in FIG. 5D, a method may include, in response to the result of the request for the authentication data satisfying the security measure, performing one or more actions authorized by the smart contract associated with recovering the private key using the first data and second data, indicated at 560d. For example, after a time out, a multi-signature protocol may allow release of the first and/or second data and private key recovery.

The example of FIG. 5E illustrates an embodiment supporting secure migration of digital assets between hosted custody and self-custody (user) digital wallets. An embodiment provides a method for securely migrating digital assets between hosted custody and self-custody wallets, including generating a custody migration contract (smart contract) that verifies asset ownership and initiates a controlled migration process.

In an embodiment, a method as shown in FIG. 5E includes splitting private key(s) into encrypted fragments, for example using multi-party computation (MPC) or threshold cryptography, ensuring that neither party has full access during migration, as illustrated at 510e and 520e. That is, in an embodiment, storing of private key fragments is completed across both the hosted custody service or wallet and a decentralized smart contract with a programmable release mechanism.

In an embodiment, a method includes verifying migration conditions, including, for example, authentication via biometric and/or multifactor authentication, hardware authentication, or multi-signature approvals, as illustrated at 530e and 540e. As with other embodiments, optionally one or more integrations are provided, for example with decentralized oracles for external verification (e.g., obtaining legal certificates, confirming legal conditions, etc.). In an embodiment, explicit user approval is used to confirm the migration.

A method may further include executing the migration, where the smart contract reconstructs the private key only after pre-set condition(s) is/are met and full control of assets is transferred without exposing the complete private key at any point, as illustrated at 550e and 560e. In an embodiment, the migration process is logged on an immutable distributed ledger for auditability. An embodiment may provide for handling failed migrations, where if the user loses access before completion, the migration automatically reverts to prevent asset loss.

Therefore, an embodiment provides secure, verifiable, and user-controlled migration of assets. An embodiment also provides seamless blockchain interoperability, e.g., where an asset is migrated to user wallets associated with different blockchain platforms. An embodiment also prevents accidental loss of assets during migration.

Referring to the example of FIG. 5E, an embodiment includes a method comprising providing, using a set of one or more processors, a hosted digital wallet that mirrors at least a portion of data of a user digital wallet, the hosted digital wallet comprising first data indicative of a first portion of a private key, indicated at 510e. In an embodiment, the method includes associating, using the set of one or more processors, the hosted digital wallet with one or more smart contracts storing second data indicative of at least a remainder of the private key that is not the first portion of the private key stored in the hosted digital wallet, indicated at 520e.

In an embodiment, a method includes determining, using the set of one or more processors, that the user digital wallet is to be migrated to a new user digital wallet based on one or more predetermined conditions specified via the one or more smart contracts, indicated at 530e. For example, a user may wish to transfer assets to a new user wallet. In an embodiment, the method includes triggering, in response to the determining and using the set of one or more processors, a request for authentication data from one or more entities, indicated at 540e. For example, an embodiment may require signatures of two or more entities, e.g., those controlling private key fragments according to an MPC protocol. Thus, in an embodiment, a method includes obtaining, using the set of one or more processors, the data indicative of the second data of the private key from the one or more smart contracts, indicated at 550e. In an embodiment, a method includes recovering, using the set of one or more processors, the private key to migrate to the new user digital wallet using the first data and second data, indicated at 560e. For example, a migration may include the smart contract reconstructing the private key according to an MPC protocol after pre-set conditions are met, allowing multi-party signing of a migration transaction and initializing the assets to the new user digital wallet, where full control of assets is transferred to the new user wallet without exposing the full private key to the migration participants at any point.

In an embodiment, the first data and the second data comprise encrypted key fragments generated using one or more of multi-party computation (MPC) and threshold cryptography. In an embodiment, the one or more smart contracts comprise a decentralized smart contract.

In an embodiment, the one or more predetermined conditions specified via the one or more smart contracts comprise completing a verification. In an embodiment, the verification comprises one or more of a biometric authentication protocol, a multi-factor authentication protocol, and a multi-signature protocol. In an embodiment, the verification comprises obtaining data from a decentralized oracle service. In an embodiment, the verification comprises explicit approval of a user associated with the digital wallet.

In an embodiment, a method includes logging one or more of the determining that the user digital wallet is to be migrated to a new user digital wallet based on one or more predetermined conditions specified via the one or more smart contracts and recovering the private key to migrate to the new user digital wallet using the first data and second data, for example recording logging data on a public distributed ledger.

In an embodiment, a method includes detecting a migration failure; and reverting, to the user digital wallet, one or more of the first data and the second data. This permits a user to revert to using a first wallet when migration to a second wallet fails.

As shown in FIG. 5F, an embodiment provides a hybrid custody escrow system with blockchain enabled crypto wallets. As users engage in high-value digital transactions, they need a secure and transparent escrow solution. An embodiment enables multiple parties to establish an escrow contract via an API or mobile app, ensuring that funds are held safely in blockchain-managed wallets. An embodiment leverages private key splitting, where each wallet holds only part of the key, and the remaining fragment is secured in a smart contract. An embodiment guarantees that no single entity can unilaterally control the funds, ensuring trust, security, and fairness.

In an embodiment, and referring to FIG. 5F, a multi-party access smart contract is set up for two or more users, for example using a hybrid custody service provider API or mobile application. The two or more users configure the smart contract to specify the holding of funds, along with terms, fees, and penalties, etc. In an embodiment, a primary crypto wallet is created for the escrow funds and matching individual wallets are created for each of the two or more users. In an embodiment, the smart contract is deployed to a blockchain platform, establishing a record of all agreed to terms. In an embodiment, the smart contract manages the private key fragment(s) and governs the conditions under which funds are released.

In an embodiment, private key security and splitting may include key division, where each wallet is secured by a private key that is split between the individual or source wallet itself and the smart contract, which holds a remainder of the key. In an embodiment, security is enhanced by the dual custody mechanism that ensures that no single party or even the hybrid custody service holds complete control over the wallets funds unless conditions specified by the smart contract are satisfied.

In an embodiment, contract execution and fund release include determining that the contract terms are satisfied and releasing the remainder of the private key (private key fragment) to the designated party as per the smart contract. Funds may thereafter be transferred accordingly, net any applicable fees, penalties, etc. In an embodiment, mutual approval of all users must be supplied to complete or trigger a next phase in processing.

In an embodiment, approval and dispute resolution is handled by using mutual consent for the release of a private key fragment secured by the smart contract. In an embodiment, a dispute mechanism is utilized where, if a dispute arises, the smart contract remains locked, and the private key is inaccessible. In an embodiment, the hybrid custody provider may interact with or engage a third-party neutral or arbitrator, which will review the dispute and solve it in exchange for a fee, which may be a share or percentage, for example as defined in a smart contract.

By way of example flow, in an embodiment, contract initiation users log into a hybrid custody platform and via API or mobile application set up an escrow smart contract by specifying, e.g., the amount and type of funds to be held and the contract terms (such as conditions, fees, penalties, etc.). In an embodiment, the hybrid custody platform may review and validate the escrow smart contract details.

Next, a wallet and escrow smart contract setup may include wallet creation, where a primary (hybrid custody) crypto wallet is created to hold the funds, and each party receives a corresponding user digital wallet with a portion of its respective private key. The escrow smart contract is deployed to the blockchain, and it securely stores the remainder of each user wallet's private key, with the smart contract encoding the terms. In an embodiment, funds are thereafter deposited by the users into the primary crypto wallet, where transaction details are recorded in a public or auditable blockchain platform.

In an embodiment, contract completion includes an approval process. For example, all parties must confirm that the escrow smart contract have been met. Once a unanimous consensus or approval is received, the escrow smart contract automatically releases the remainder of the private key fragment(s) to the party entitled to the funds and executes transfer of the funds, deducting any fees or penalties, etc.

In an example embodiment, acceptance criteria for a dual custody or escrow arrangement include partial key storage, conditional key and funds release, mutual approval requirements, and dispute resolution mechanisms. With respect to partial key storage or hybrid custody, each wallet only holds a part of the associated or needed private key, the other remaining key fragment being stored in a smart contract. In terms of conditional key and funds release, after satisfaction of all terms and conditions of the smart contract, the smart contract sends the remaining portion of the private key to the designated party and the transfer of funds is executed, after deductions, if any. With respect to mutual approval requirements, an embodiment requires all parties to approve the stage or completion of the escrow smart contract. If approval is not unanimous, the escrow smart contract will not release the private key fragment or funds. In an embodiment, such a comprehensive approach ensures all parties are protected, transactions are securely managed, and disputes, if any, are resolved in a fair manner, leveraging the robust security of blockchain technology and transparency of smart contracts.

Accordingly, as shown in FIG. 5F, an embodiment implements a method including providing, using a set of one or more processors, a hosted digital wallet that is associated with a first user digital wallet, the hosted digital wallet comprising first data indicative of a first portion of a private key, indicated at 510f. In an embodiment, a method includes associating, using the set of one or more processors, the hosted digital wallet with a smart contract storing second data indicative of at least a remainder of the private key that is not the first portion of the private key stored in the hosted digital wallet, indicated at 520f. In an embodiment, a method includes determining, using the set of one or more processors, that one or more predetermined conditions specified via the smart contract is satisfied, indicated at 530f. For example, the one or more predetermined conditions comprise receipt of data from a third-party source. By way of further example, the third-party source is a distributed oracle providing the data, confirming the one or more predetermined conditions of the smart contract has occurred. In an example, the one or more predetermined conditions comprise receipt of a mutual consent from a first user associated with the first user digital wallet and a second user associated with the second user digital wallet. In a further example, the one or more predetermined conditions comprise receipt of a third-party consent after failing to receive a mutual consent from a first user associated with the first user digital wallet and a second user associated with the second user digital wallet. For example, the third-party consent is received from an entity designated in the smart contract, e.g., an arbitrator. In an embodiment, a method may include providing an application programming interface (API) supplying a current status of the smart contract, e.g., to monitor decision(s) of the arbitrator.

In an embodiment, a method includes obtaining, using the set of one or more processors, the data indicative of the second data of the private key from the smart contract, indicated at 540f. In an embodiment, a method includes recovering, using the set of one or more processors, the private key using the first data and second data, indicated at 550f. In an embodiment, the recovering at 550f includes providing one or more of the first data and the second data to a second user digital wallet, as specified in the smart contract, allowing the second user digital wallet to recover the private key. In an embodiment, the hosted digital wallet comprises assets conditionally held for one or more of the first user digital wallet and the second user digital wallet. In an embodiment, the first or second user digital wallets do not have access to the second data and require conditional release of the second data by the smart contract. In an embodiment, the first and second user wallets may have access to respective first data, e.g., a part of the wallet's private key (which may be the same). Further, in an embodiment, the remainder of the private key may be unique to the user digital wallet, e.g., the smart contract may store different key fragments for respective user digital wallets that are conditionally released to claim funds.

An embodiment as outlined in FIG. 5F may be utilized to facilitate escrow smart contracts in many different contexts, including wagering. For example, in high-stakes bet/wager scenarios, parties require a secure, transparent, and automated way to manage funds. An embodiment such as described in FIG. 5F allows two or more parties to configure a bet/wager smart contract via a hybrid custody provider API or mobile app. Once configured, a dedicated crypto wallet may be created for the wager, and funds are deposited into it. Matching individual wallets are also generated for each party, while a blockchain escrow smart contract enforces the agreed-upon terms. By employing private key splitting, where each wallet holds only part of the key and the remainder is secured in the smart contract, an embodiment ensures that no single entity can unilaterally access or control the funds.

Further, an embodiment such as described in connection with FIG. 1 through FIG. 5 may be utilized in an encrypted password manager with blockchain-enabled hybrid custody. In an embodiment, the assets protected via private key may be passwords. For example, a user of password managers wants a secure solution that ensures passwords are encrypted and protected from unauthorized access, including by the service provider, hackers, officials, or any third party. This will allow the user to safely manage passwords without risking their exposure or losing access to them. By encrypting the passwords with a private key, a portion of which is stored in a hybrid custody wallet and the remainder of which is stored by a smart contract, the user can be assured that even with a lack of access to the private key, e.g., access via a master password, a recovery of the private key is possible and use of the secured passwords ensured in a manner that protects their exposure to third parties. For example, users have a unique master password, known only to them, which functions like a private key in cryptocurrency wallets. It grants access to their account and authorizes devices.

For example, in an embodiment users can download a password manager application from a store and create an account. The application supports secure onboarding, including creating a master password. Users can add, edit, and delete account credentials. All passwords are encrypted locally before being stored on the blockchain. Encryption key splitting is handled as described herein, i.e., passwords are encrypted with a key that is split between the hybrid custody service provider and the blockchain smart contract. A ping system may be utilized as described herein, e.g., the smart contract pings the user's application at intervals and users receive notifications and can respond to maintain the key split.

In an embodiment, the recovery process for passwords is managed as described herein, e.g., if the user fails to respond to a ping, the smart contract released the key remainder to or by the hybrid custody service provider, e.g., users or designees may retrieve the encrypted data and reset the master password, which is only known to the user and functions like a private key as it provides secure access to the app and authorizes devices.

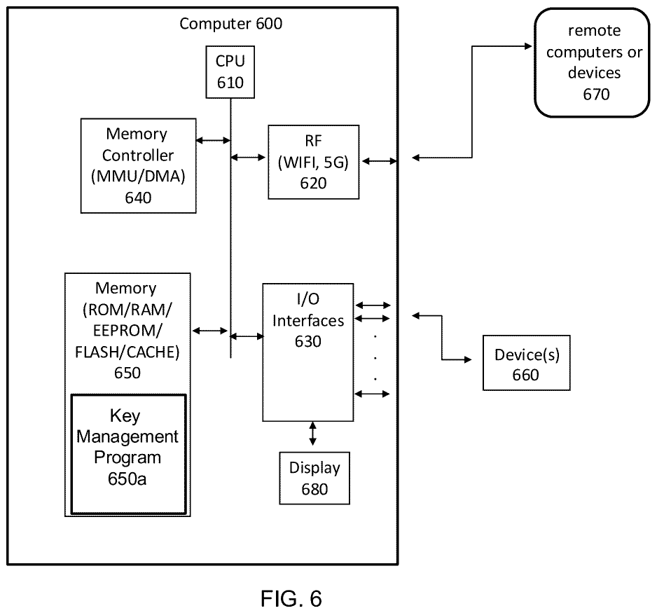

Referring to FIG. 6, it will be readily understood that certain embodiments can be implemented using any of a wide variety of devices or combinations of devices and components. In FIG. 6 an example of a computer 600 and its components are illustrated, which may be used in a device such as processing component 150 of a host custody service provider for implementing the functions or acts described herein, e.g., executing a key management program 650a implementing acts or subsets thereof of FIG. 2, FIG. 3, and FIG. 5. Also, circuitry other than that illustrated in FIG. 6 may be utilized in one or more embodiments. The example of FIG. 6 includes certain functional blocks, as illustrated, which may be integrated onto a single semiconductor chip to meet specific application requirements.

One or more processing units are provided, which may include a central processing unit (CPU) 610, one or more graphics processing units (GPUs), and/or micro-processing units (MPUs), which include an arithmetic logic unit (ALU) that performs arithmetic and logic operations, instruction decoder that decodes instructions and provides information to a timing and control unit, as well as registers for temporary data storage. CPU 610 may comprise a single integrated circuit comprising several units, the design and arrangement of which vary according to the architecture chosen.

Computer 600 also includes a memory controller 640, e.g., comprising a direct memory access (DMA) controller to transfer data between memory 650 and hardware peripherals. Memory controller 640 includes a memory management unit (MMU) that functions to handle cache control, memory protection, and virtual memory. Computer 600 may include controllers for communication using various communication protocols (e.g., I²C, USB, etc.).

Memory 650 may include a variety of memory types, volatile and nonvolatile, e.g., read only memory (ROM), random access memory (RAM), electrically erasable programmable read only memory (EEPROM), Flash memory, and cache memory. Memory 650 may include embedded programs, code, and downloaded software, e.g., key management program 650a that provides coded methods such as illustrated and described in connection with FIGS. 2, 3 and 5 (or parts thereof). By way of example, and not limitation, memory 650 may also include an operating system, application programs, other program modules, code, and program data, which may be downloaded, updated, or modified via remote devices.

A system bus permits communication between various components of the computer 600. I/O interfaces 630 and radio frequency (RF) devices 620, e.g., Wi-Fi and telecommunication radios, may be included to permit computer 600 to send data to and receive data from remote devices using wireless mechanisms, noting that data exchange interfaces for wired data exchange may be utilized. Computer 600 may operate in a networked or distributed environment using logical connections to one or more other remote computers or devices 670, such as a set of devices that implements a distributed ledger, such as smart contract blockchain 140. The logical connections may include a network, such local area network (LAN) or a wide area network (WAN) but may also include other networks/buses. For example, computer 600 may communicate data with and between device(s) 660, for example personal user device(s) that provide communication and data connectivity to self-custody wallet 120.

Computer 600 may therefore execute program instructions or code configured to provide hosted custody wallet, smart contracts, and perform other functionality of the embodiments, such as described in connection with FIGS. 2, 3 and 5 (or parts thereof). A user can interface with (for example, enter commands and information) the computer 600 through input devices, which may be connected to I/O interfaces 630. A display 680 or other type of output device may be connected to or integrated with the computer 600, for example via an interface selected from I/O interfaces 630.

It should be noted that the various functions described herein may be implemented using instructions or code stored on a memory, e.g., memory 650, that are transmitted to and executed by a processor, e.g., CPU 610. Computer 600 includes one or more storage devices that persistently store programs and other data. A storage device or computer readable medium, as used herein, is a non-transitory computer readable medium. Some examples of a non-transitory computer readable medium include, but are not limited to, storage integral to computer 600, such as memory 650, a hard disk or a solid-state drive, and removable storage, such as an optical disc or a memory stick.

Program code stored in a memory or storage device may be transmitted using any appropriate transmission medium, including but not limited to wireless, wireline, optical fiber cable, RF, or any suitable combination of the foregoing.

Program code for carrying out operations according to various embodiments may be written in any combination of one or more programming languages. The program code may execute entirely on a single device, partly on a single device, as a stand-alone software package, partly on single device and partly on another device, or entirely on the other device. In an embodiment, program code may be stored in a non-transitory medium and executed by a processor to implement functions or acts specified herein. In some cases, the devices referenced herein may be connected through any type of connection or network, including a local area network (LAN) or a wide area network (WAN), or the connection may be made through other devices (for example, through the Internet using an Internet Service Provider), through wireless connections using a mobile network, or through a hard wire connection, such as over a USB connection.

An embodiment may be implemented in a variety of devices, including user devices such as mobile user device running a mobile wallet application. It should therefore be understood that in an embodiment, computer 600 may take the form of a mobile phone having a suitable self-custody wallet program, e.g., including components of key management program 650a, permitting interaction with hosted custody wallet 430, smart contract blockchain, or a combination of the foregoing.

Therefore, an embodiment may include an application program configured to execute computer program instructions, for example as outlined at least in part in FIGS. 2, 3, and 5, which in combination with device hardware such as a processor and non-transitory memory storing code, permit realization of private key management as described herein.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” or “the” preceding an element does not exclude the presence of a plurality of such elements. The mere fact that certain elements are recited in mutually different dependent claims does not indicate that these elements cannot be used in combination. The word “about” or similar relative term as applied to numbers includes ordinary (conventional) rounding of the number with a fixed base such as 5 or 10.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized or omitted as appropriate, as the explicit illustrated examples are used only for descriptive purposes and are not to be construed as limiting.

As used herein, the statement that two or more parts or components are “coupled” shall mean that the parts are joined or operate together either directly or indirectly, e.g., through one or more intermediate parts or components, so long as a link occurs. As used herein, “operatively coupled” means that two or more elements are coupled to operate together or are in communication, unidirectional or bidirectional, with one another. As used herein, the term “number” shall mean one or an integer greater than one (i.e., a plurality). As used herein a “set” shall mean one or more.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A method, comprising:
providing, using a set of one or more processors, a hosted digital wallet that mirrors at least a portion of data of a user digital wallet, the hosted digital wallet comprising first data indicative of a first portion of a private key;
associating, using the set of one or more processors, the hosted digital wallet with a smart contract storing second data indicative of at least a remainder of the private key that is not the first portion of the private key stored in the hosted digital wallet;
determining, using the set of one or more processors, that the user digital wallet is not compliant with one or more predetermined conditions specified via the smart contract;
acquiring, using the set of one or more processors, authentication data from one or more entities;
requiring, using the set of one or more processors, that the authentication data satisfy a security measure; and
in response to the authentication data satisfying the security measure, performing one or more actions authorized by the smart contract associated with recovering the private key using the first data and second data.

2. The method of claim 1, wherein the security measure is one or more of a biometric authentication protocol, a multi-factor authentication protocol, and a multi-signature protocol.

3. The method of claim 1, wherein the multi-factor authentication protocol comprises a multi-entity authentication process.

4. The method of claim 2, wherein the authentication data is indicative of multi-entity consent that satisfies the multi-signature protocol.

5. The method of claim 4, wherein the multi-signature protocol comprises a threshold requirement for having a predetermined number of signatures.

6. The method of claim 1, wherein the requiring that the authentication data satisfy the security measure includes confirming biometric data matches one or more predetermined entities.

7. The method of claim 1, wherein the one or more entities are defined by one or more predefined user roles.

8. The method of claim 7, comprising determining one or more predefined conditions have occurred;
wherein the one or more predefined conditions occurring enables the one or more predefined user roles.

9. The method of claim 8, wherein the one or more predefined conditions comprise satisfying a condition of a beneficiary arrangement specified via the smart contract.

10. The method of claim 9, wherein the one or more predefined user roles are thereafter authorized to recover the private key.

11. A system, comprising:
a set of one or more processors; and
a non-transitory storge device comprising code executable by the set of one or more processors, the code being configurable for:
providing a hosted digital wallet that mirrors at least a portion of data of a user digital wallet, the hosted digital wallet comprising first data indicative of a first portion of a private key;
associating the hosted digital wallet with a smart contract storing second data indicative of at least a remainder of the private key that is not the first portion of the private key stored in the hosted digital wallet;
determining that the user digital wallet is not compliant with one or more predetermined conditions specified via the smart contract;
acquiring authentication data from one or more entities;
requiring that the authentication data satisfy a security measure; and
in response to the authentication data satisfying the security measure, performing one or more actions authorized by the smart contract associated with recovering the private key using the first data and second data.

12. The system of claim 11, wherein the security measure is one or more of a biometric authentication protocol, a multi-factor authentication protocol, and a multi-signature protocol.

13. The system of claim 11, wherein the multi-factor authentication protocol comprises a multi-entity authentication process.

14. The system of claim 12, wherein the authentication data is indicative of multi-entity consent that satisfies the multi-signature protocol.

15. The system of claim 14, wherein the multi-signature protocol comprises a threshold requirement for having a predetermined number of signatures.

16. The system of claim 11, wherein the requiring that the authentication data satisfy the security measure includes confirming biometric data matches one or more predetermined entities.

17. The system of claim 11, wherein the one or more entities are defined by one or more predefined user roles.

18. The system of claim 7, wherein the code is configurable for determining one or more predefined conditions have occurred;
wherein the one or more predefined conditions occurring enables the one or more predefined user roles.

19. The system of claim 18, wherein the one or more predefined conditions comprise satisfying a condition of a beneficiary arrangement specified via the smart contract, wherein the one or more predefined user roles are thereafter authorized to recover the private key.

20. A computer program product, comprising:
a non-transitory medium comprising code executable by a set of one or more processors, the code being configurable for:
providing a hosted digital wallet that mirrors at least a portion of data of a user digital wallet, the hosted digital wallet comprising first data indicative of a first portion of a private key;
associating the hosted digital wallet with a smart contract storing second data indicative of at least a remainder of the private key that is not the first portion of the private key stored in the hosted digital wallet;
determining that the user digital wallet is not compliant with one or more predetermined conditions specified via the smart contract;
acquiring authentication data from one or more entities;
requiring that the authentication data satisfy a security measure; and
in response to the authentication data satisfying the security measure, performing one or more actions authorized by the smart contract associated with recovering the private key using the first data and second data.

21.-72. (canceled)
